(19) United States
(12) Patent Application Publication
(10) Pub. No.: US 2008/0223294 A1
(43) Pub. Date: Sep. 18, 2008

(54) Flooding Chamber For Coating Installations

(75) Inventors: Thomas Gebele, Freigericht (DE); Andreas Lopp, Freigericht (DE); Oliver Heimel, Wabern (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 11/769,807

(22) Filed: Jun. 28, 2007

Related U.S. Application Data
(60) Provisional application No. 60/894,753, filed on Mar. 14, 2007.

(51) Int. Cl. B05C 3/02

(52) U.S. Cl. 118/429

(57) ABSTRACT

The invention relates to a flooding chamber for coating installations, with which shorter flooding times, and therewith shorter clock cycles, can be attained. Two flooding means are therein utilized, between which a substrate is disposed symmetrically. The flooding means direct a gas jet directly onto the substrate. Hereby the substrate is fixed between the flooding means.

### CROSS-REFERENCES TO RELATED APPLICATIONS

This application is a non-provisional, and claims the benefit, of commonly assigned U.S. Provisional Application No. 60/894,753, filed Mar. 14, 2007, entitled “Flooding Chamber For Coating Installations,” the entirety of which is herein incorporated by reference for all purposes.

### BACKGROUND OF THE INVENTION

The invention relates to flooding chambers for coating installations.

In high vacuum coating installations feed-in and feed-out lock chambers are often provided disposed in front of or following, respectively, the high vacuum coating chamber. The substrates to be coated, for example glass sheets, are guided through these feed-in and feed-out chambers so as not to have to re-evacuate the entire high vacuum coating chamber with each individual substrate. While the feed-in chamber has the function of transferring the substrate from the region of atmospheric pressure into the vacuum region, the feed-out chamber has the task of transferring the now coated substrate from vacuum into the region of atmospheric pressure.

A coating installation with a feed-in chamber, a process chamber and a feed-out chamber is disclosed, for example, in FIG. 1 of DE 10 2004 008 598 A1. Between the feed-in and feed-out chamber, on the one hand, and the process chamber on the other, buffer chambers may additionally be provided. Such a coating installation is also referred to as an inline installation.

In the inlet chamber the pressure is brought to a suitable transfer pressure, for example to p=5·10⁻³ hPa. In the succeeding process chamber a pressure of, for example, p=1·10⁻³ hPa then obtains, while the pressure in the feed-out chamber following thereon is brought from process chamber pressure to atmospheric pressure.

The time required to bring the feed-in chamber to the requisite transfer pressure at given substrate transport and valve switching times is a significant determinant of the cycle time.

In new installations, in which increasingly more frequently very thin glass sheets or other areal substrates are coated, the time required to bring the feed-out chamber to the required pressure has become increasingly more important. Since under rapid flooding the substrates are readily destroyed or damaged, only flooding times in the range from 8 sec to 12 sec can be attained.

One component decisive for the productivity of an inline coating installation is the cycle time or clock cycle, i.e. the time which must be expended for each substrate coating. To attain a cycle time of 45 sec the lock system must be capable of moving a substrate in less than 45 sec from a point under atmospheric pressure to a point in the high vacuum region and conversely. Within this time the substrate must be transported into and out of the locks, and the locks must be evacuated or ventilated. The time available for the evacuation and flooding is then as a rule less than the cycle time, for example 20 seconds of the 45 seconds, since all other tasks must also be completed within the cycle time.

According to the known equation

|t=(V/S)·ln(p₀/p₁)

with

t=pumping time

V=volume

S=pump suction capacity

p₀=initial pressure (atmospheric pressure)

p₁=target pressure (transfer pressure, final lock pressure)

it follows that the pumping time, and therewith also the cycle time, can be shortened using the following measures:
reducing the volume of the lock chambers
increasing the pump suction capacity
lowering the ratio of p₀ to p₁.

As a rule, in practice the reduction of the volume of the lock chambers is preferred. Unfortunately, the volume reduction frequently entails the negative effect that under rapid flooding, greater pressure differences are generated in the locks, which destroy the substrates or bring them out of their position.

A device for transporting a flat substrate in a vacuum chamber is already known in which, opposite one side of the flat substrate, a gas channel with bores directed onto the flat substrate is provided (WO 2004/096678 A 1). The gas cushion available herein prevents the substrate from resting on a support and being damaged.

Furthermore, a cascade-form gas supply for a vacuum chamber, in which several openings in a wall are fed from the same gas source is known in the art (DE 101 19 766 A 1).

The known devices, however, do not involve the shortening of the cycle time. Accordingly, there is a need in the art, therefore, for systems and methods that shorten the cycle time.

### BRIEF SUMMARY OF THE INVENTION

The problem may be solved according to the various embodiments of the present invention.

The invention consequently relates to a flooding chamber for coating installations with which shorter flooding times, and therewith shorter clock cycles, can be attained. Herein two flooding means are utilized between which a substrate is disposed symmetrically. The flooding means direct a gas jet directly onto the substrate. Hereby the substrate is fixed between the flooding means.

The advantage obtained with the invention comprises in particular that through the rapid flooding by means of a high gas flow the substrate is not blown down off the transport system and against the lock chamber walls. Thereby that the substrate is acted upon by flow forces which cancel each other at the substrate, there is no force which could overturn the substrate.

Through the shortening of the flooding time by, for example, 10 seconds to about 2 seconds, the cycle time can be reduced by, for example, by 8 seconds. A further advantage of the invention is that the substrate during the flooding is fixed between the flooding means, i.e., the flooding means themselves act as a contact-free holder for the substrate. A damping coupling is simultaneously formed between substrate and flooding means, which counteracts possible oscillations of the substrate.

In contrast to the known air cushion transport of flat substrates, in the present invention the substrate is retained securely at several sites locally by a high dynamic pressure—realized through gas jets—i.e., it is centrally fixed. The static pressure, resulting from the gas streaming into the chamber volume, is hindered from displacing the substrate out of the plane of transport.

### BRIEF DESCRIPTION OF THE DRAWINGS

Embodiment examples of the invention are shown in the drawing and will be described in further detail in the following. Therein depict:

FIG. 1 a schematic diagram of an inline coating installation with a feed-in chamber, a process chamber and a feed-out chamber,

FIG. 2 a view onto the narrow side of the feed-out chamber,

FIG. 3 a view onto a feed-out chamber with two gas supplies,

FIG. 4 a view onto a feed-out chamber with centered gas supply,

FIG. 5 a representation of the forces acting onto a substrate,

FIG. 6 a representation of the forces acting onto a tilted substrate,

FIG. 7a a perspective view of a further embodiment of a feed-out chamber,

FIG. 7b a front view of the feed-out chamber depicted in FIG. 7a.

### DETAILED DESCRIPTION OF THE INVENTION

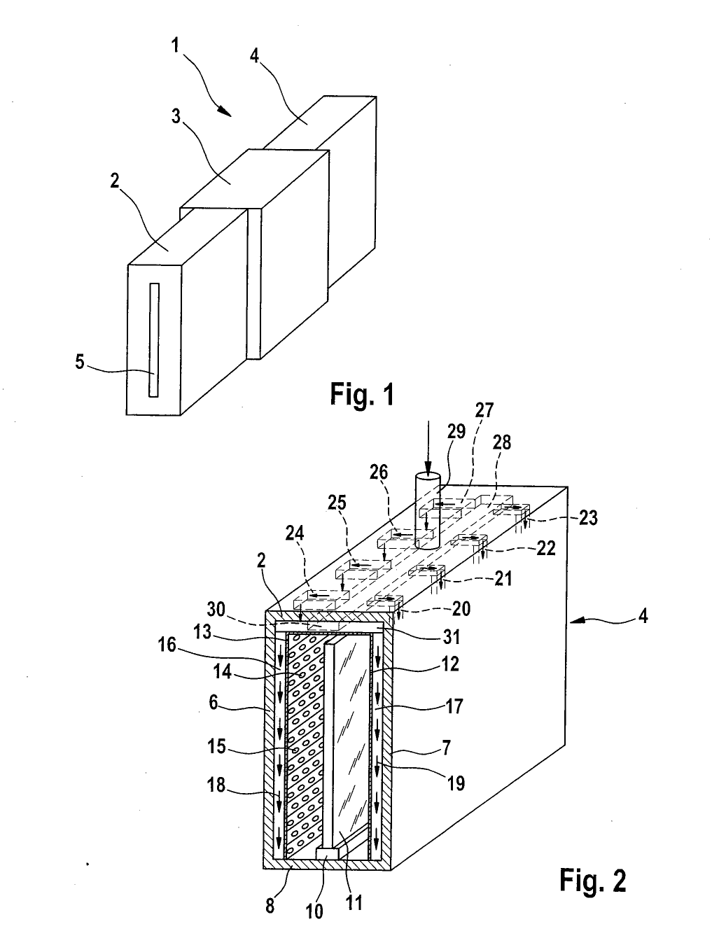

FIG. 1 shows a schematic diagram of an inline coating installation 1 with a feed-in chamber 2, a process chamber 3 and a feed-out chamber 4. An areal substrate to be coated, for example a glass plate, is introduced through an opening 5 of the feed-in chamber 2 and transported to the process chamber 3, where the substrate is coated. After the coating the substrate reaches the feed-out chamber 4 and from here is transported to the outside.

FIG. 2 shows once again the feed-out chamber 4 in isolation. Four lock chamber walls 6 to 9 can be seen as well as a transport device 10 for a substrate 11, which here is a glass plate. By 12 and 13 are denoted flood walls, which are provided with several holes 14, 15. The flood walls 12, 13 form together with the insides of the lock chamber walls 6, 7 a flood channel 16, 17, through which flows gas which subsequently penetrates through the holes 14,15. The gas flow is indicated by arrows 18, 19. The supply of the gas takes place via several side channels 20 to 27, which, in turn, are connected with a centered main channel 28 fed via a gas supply tube 29. The main channel 28 is herein formed by a recess 30 in a ceiling wall 31. The ceiling wall 31 also has recesses at those sites at which side channels 20 to 27 enter the flood channels 16, 17.

The flood gas consequently arrives via the gas inlet tube 29 in the main channel 28 and from here reached the side channels 20 to 27, which terminate in the flood channels 16, 17. From here the flood gas penetrates through holes 14,15 and impinges on the substrate 11. The substrate 11 is simultaneously blown on from the two flood channels 16, 17.

The emission of the gas from the flood walls 12, 13 must be identical and mirror symmetrical, i.e., the holes corresponding to one another of the flood walls 12, 13 are directly opposing one another. However, a minimal offset can also be advantageous with respect to the holding effect and resonance.

It is important that the feed-in of the gas into the flood channels 16, 17 takes place symmetrically and that the same quantity of gas always enters the flood channels at the same rate. Nozzles, gaps and the like may also be utilized instead of holes.

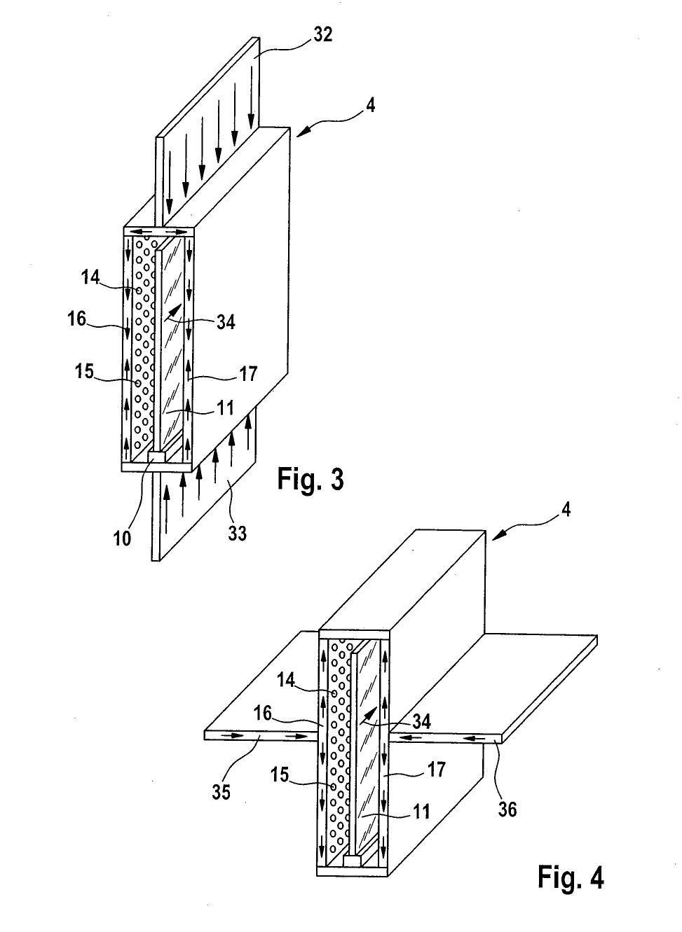

FIG. 3 shows the same feed-out chamber 4 as FIG. 2, however schematically and highly simplified. It is evident that the gas supply may not only take place from above but also from below or from above and below. For this purpose two gas supplies 32,33 are provided which terminate in the flood channels 16, 17. As in the embodiment of FIG. 2, the transport of substrate 11 takes place in the direction of arrow 34. Due to the second gas supply 33, the gas flow through the flood channels 16, 17 can be made uniform, i.e., through the lower holes flows the same amount of gas as through the upper ones.

In FIG. 4 a feed-out chamber 4 is shown which comprises two centrally disposed gas supplies 35, 36 extending perpendicularly to the flood channels 16, 17. These central gas supplies 35, 36 ensure that the gas is uniformly distributed in the lower and upper region of the flood channels 16, 17.

FIGS. 3 and 4 do not show that the gas supplies 32, 33 or 35, 36 operate symmetrically, i.e., the gases flowing through gas supplies 32, 33 and 35, 36 originate from a common source. Without symmetric division of the gas flow, a complex and expensive regulation would be necessary, which ensures that the same gas flow is supplied to the flooding walls on both sides.

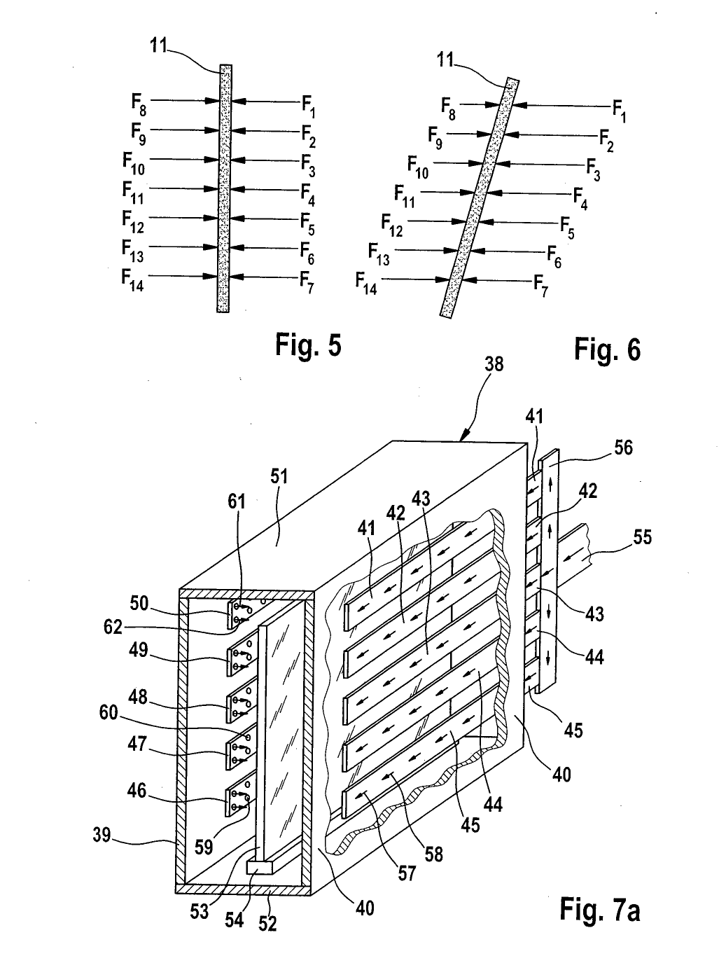

FIG. 5 shows that the forces acting onto the substrate cancel each other. The forces F₁ to F₁₄ originating from a gas pressure flowing out of holes 14, 15, are all of the same magnitude. However, forces F₈ to F₁₄ are directed oppositely to forces F₁ to F₇, such that the forces cancel each other at substrate 11.

FIG. 6 shows the manner in which the forces caused by the gas flow behave if the substrate 11 is inclined to one side. Since the substrate 11 in this case approaches the upper openings of a flooding wall 12, 13, the gas flowing out of them exerts a greater force which is expressed through a long force arrow F₁. Hereby the substrate is set upright again, i.e., moved into the perpendicular position.

Specifications of magnitude of the dynamic pressure can only be made with difficulty, since the pressure depends on a large number of factors affecting it and must be optimized for the individual case or be empirically determined. A light gas, for example hydrogen, generates a lower pressure than a heavy gas, for example xenon. Furthermore, the number of holes and their cross section determine the pressure. The distance between the flooding bars and the substrate also represents an influence factor, as does the gas throughput.

Moreover, the dynamic pressure varies during the flooding time, since at increasing static pressure in the chamber, on the one hand, the expansion of the gas jets decreases, which increases the force effect onto the substrate; however, on the other hand, the force effect decreases through increasing vorticity.

The gas utilized for flooding is not critical. However, cost-effective gases are preferred. Since in the rapid flooding according to the invention against both sides of the substrate 11 a gas flow of high speed is blown, it is essential that a clean, dry and especially particle-free gas is used in order not to damage the coating during the flooding. Such a gas, which meets the requirements, is for example nitrogen, which can be stored in large quantities in a holding tank. However, air can also be utilized if it is previously dried, purified or at least filtered.

In the lock chamber may be particles, which, for example, have been generated in the coating process and are deposited on the coating. If the gas stream did impinge on the coating, the particles are transported into the chamber such that the substrate is largely kept free of particles during the flooding.

To introduce the necessary quantities of gas in the shortest possible time into the lock chamber, either a large number of holes 14, 15 or holes of large size may be provided. However, additional gas lances or flooding facilities may be provided whose direction of gas emission is not directed toward the substrate 11. The requisite condition is here that through the additional gas supplies no vortices must be generated in the flow, which move the substrate from its position or blow it away.

Although a gas conduction bar—as described for example in DE 103 19 379 A 1—may be satisfactory, it is recommended that the holes 14, 15 are distributed over the entire wall 18.

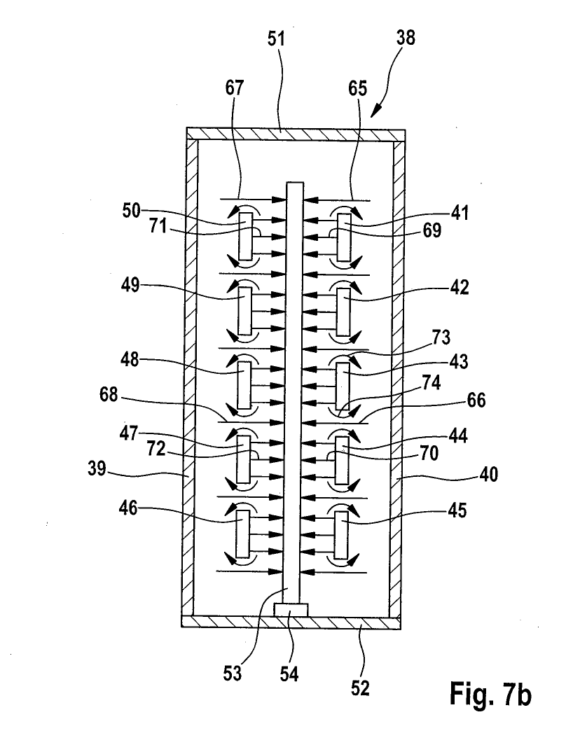

FIG. 7a depicts a further embodiment of the invention in which, instead of flooding walls, flooding bars are provided.

A feed-out chamber 38 comprising two side walls 39, 40, is provided with a total of ten flooding bars 41 to 45 and 46 to 50, of which five flooding bars each are disposed opposite to one another. The feed-out chamber is closed off at the top and bottom by a ceiling wall 51 and a bottom 52. The flooding bars 41 to 45 are visible in FIG. 7a, since the side wall 40 is shown broken through. Between the opposing flooding bars is located a substrate 53 which rests with one edge on a transport device 54. Supplying the flooding bars 41 to 50 with gas takes place via a gas supply 55 coupled with a gas branching 56 which, in turn, adjoins the flooding bars 41 to 45. The flooding bars 46 to 50—which are not visible in FIG. 7a—are supplied in the same manner with gas. The streaming of the gas in the flooding bars is indicated with arrows 57, 58. Since the flooding bars 41 to 50 are provided on their inwardly directed side with holes 59, 60, the gas is emitted in the direction toward the substrate 53. This is indicated by arrows 61, 62.

The flooding facility depicted in FIG. 7a can also be rotated by 90 degrees without losing its functional capabilities. The flooding bars 41 to 50 and the gas supply 55 would in this case extend perpendicularly, while the gas branching 56 would extend horizontally. Substrate 53, the lock opening and the transport device 54 would in this case retain their direction.

FIG. 7b shows the feed-out chamber 38 in front view. It can be seen that the flooding bars 41 to 50 are spaced apart from one another in the vertical direction. This spacing is chosen in order to cancel a possible negative effect of the static pressure. By static pressure is understood that pressure which normally is obtained in the feed-out chamber 38. In contrast, by dynamic pressure is understood that pressure which is generated by the gas emitted from the flooding bars 41 to 50 in the direction toward the substrate 53.

The static pressure is characterized in FIG. 7b through arrows 65 to 68, while the dynamic pressure is indicated through arrows 69 to 72. The arrows 73, 74 indicate that the gas jets 69, 70 impinging on substrate 53 are deflected again in the direction toward the wall 40. Due to both pressures, forces act onto substrate 53. Utilizing flooding bars 41 to 50, instead of continuous flooding walls, prevents different pressures from building up on the sides to the right and left of the substrate. If, when using continuous walls, the substrate 53 partitions the feed-out chamber 38 into two compartments, the overflow between the two compartments is hindered through high flow resistances and different static pressures build up on the two sides. The static pressure differences resulting herefrom can destroy the substrate 53 or move it from the center position. Using the flooding bars prevents this, since, on the one hand, the high dynamic pressure arising from it is superimposed onto the relatively low static pressure and since, on the other hand, due to the vertical distances between the flooding bars an additional pressure equalization is created between the two sides of the substrate.

The static pressure is not a fixed value, since lock chambers are filled from the pressure level of a process chamber—approximately 1·10⁻³ hPa—up to atmospheric pressure. It is irrelevant whether the flooding bars 41 to 50 are disposed horizontally or vertically. However, it is important that the gas flowing in via the flooding bars 41 to 50 is introduced symmetrically with respect to substrate 53, has a stabilizing and damping effect on the substrate 53 and the remaining chamber volume is flooded such that the static pressure building up cannot damage the substrate 53.

To attain a specific holding effect through the dynamic pressure, the sum of the cross sectional areas of the holes in the flooding bars should be less or equal to the associated inlet cross section of the particular flooding facility.

A rotation by 90 degrees, as described in connection with FIG. 7a, is also possible with the configuration according to FIG. 7b. In this case FIG. 7b would be a top view.

1. A flooding chamber for coating plane substrates, comprising at least two flooding units having a plurality of fluid penetration openings, one of the flooding units being arranged on the one side of the plane substrate and the other flooding unit being arranged on the other side of the plane substrate, wherein the at least two flooding units connected to at least one fluid source at a given fluid pressure.

2. The flooding chamber according to claim 1, wherein the flooding units comprise flooding walls which comprise a plurality of fluid penetration openings.

3. The flooding chamber according to claim 2, further comprising a substrate, wherein at least a portion of the fluid penetration openings is directed toward the substrate.

4. The flooding chamber according to claim 1, wherein the flooding units comprise flooding bars which comprise several fluid penetration openings.

5. The flooding chamber according to claim 4, wherein the flooding bars are spaced apart from one another in the horizontal direction.

6. The flooding chamber according to claim 1, wherein the fluid is air.

7. The flooding chamber according to claim 1, wherein the fluid is nitrogen.

8. The flooding chamber according to claim 2, further comprising exterior walls, wherein the exterior walls and the flooding walls form a hollow space.

9. The flooding chamber according to claim 2, wherein the fluid penetration openings are distributed over one side of a flooding wall and each are disposed same distance from one another.

10. The flooding chamber according to claim 8, wherein the hollow spaces are connected to a common fluid source.

11. The flooding chamber according to claim 8, wherein the hollow spaces are connected to two common fluid sources.

12. The flooding chamber according to claim 8, wherein the hollow spaces comprise a narrow side and the fluid sources are connected with the narrow sides of the hollow spaces.

13. The flooding chamber according to claim 10, wherein the fluid source is connected with the center lines of the hollow spaces.

14. The flooding chamber according to claim 11, wherein the fluid sources are connected with the center lines of the hollow spaces.
